(19) United States
(12) Patent Application Publication
(10) Pub. No.: US 2003/0076858 A1
(43) Pub. Date: Apr. 24, 2003

(54) Multi-layer data transmission system

(75) Inventor: Sachin G. Deshpande, Vancouver, WA (US)

Correspondence Address: MARGER JOHNSON & McCOLLOM, P.C., 1030 S.W. Morrison Street, Portland, OR, 97205, US

(73) Assignee: Sharp Laboratories of America, Inc., Camas, WA

(21) Appl. No.: 10/055,207

(22) Filed: Oct. 19, 2001

(51) Int. Cl. H04J 3/16; H04J 3/22

(52) U.S. Cl. 370/468

(57) ABSTRACT

A data transmission scheduler sends different layers of data transmissions over a network at different times, according to available bandwidth. Data in the lowest layer is always sent immediately, without any delay, to form a basic image. Data in a higher layer or layers, which enhances the basic image, is sent during time periods of bandwidth otherwise unused. The scheduler operates to maintain an overall datarate equal to an average target bitrate. In other embodiments the scheduler can also maintain a maximum bursting datarate below a preset maximum.

### TECHNICAL FIELD

This disclosure relates to data transmission and, more particularly, to a data transmission system that schedules delivery of different data layers depending on available bandwidth in the transmission system to achieve an overall target average data transmission rate.

### BACKGROUND

Most data transmission systems have limits on how much data can be transmitted over them per unit time. Extending the transmission time may work for some applications, such as for transmitting a file over a network, but does not work well for time-sensitive applications, such as real-time audio and video, where slow moving or incomplete video or audio is easily perceived and is very disturbing.

Modern real-time audio or video data transmission systems include an encoder to encode an audio or video input stream into transmittable data, a data channel for transmitting the encoded data, and a decoder for decoding the transmitted data and recreating the audio or video stream at a receiver. Because simply encoding the input stream would result in an extremely large data file, typical encoders also compress the audio or video data to make a smaller data file to be transmitted.

Present encoders are well suited to compress an average video pattern into an available bandwidth. However, when the video pattern changes more than average from frame to frame, or when a strong burst of new video data is presented to the encoder, most encoders cannot keep up with the amount of encoding and compression that needs to be performed. Or, the encoder may be restricted in how much data it can transmit over the data channel and does not have enough time to fully encode the input to fit within the data restrictions. This causes the decoder to produce choppy or incomplete video.

Modern encoding systems use rate control algorithms when encoding data. Encoders compress and/or otherwise prepare the data to achieve a specified channel target bit rate of sending the encoded data over the data channel. These rate control algorithms generally work by varying the quality of the compression encoding prior to sending the coded data to the transmission medium. When the data only requires minimal or average encoding to fit within the allocated bandwidth, bandwidth limitations generally can be met. When the data requires a more than average amount of encoding to fit within the allocated bandwidth, problems arise.

Most video compression algorithms create more data when an image is changing rapidly compared to one that is relatively still from frame to frame. One way to compress video data is to create successive new frames by sending to the decoder only the differences between the current video frame and its previous frame. If there are many differences, much data needs to be sent. If there are not too many differences (a static background, for example) less data can be sent to create the new frame.

Present ways to change the quality of the encoding to fit within the available bandwidth include varying the quantization step size and/or by skipping frames in the audio or video. When operating in limited bandwidth situations, these systems cause the video quality to be at its worst when video content is rapidly changing, which is exactly when the user would benefit by the video quality being at its best. During these times when the video is rapidly changing, the bandwidth limitations do not allow for best quality video because too many areas of the images are changing. If there were unlimited bandwidth, then all of the changed video data could be sent; but, because bandwidth is limited, some of the video data must be dropped during encoding. This causes poor quality video transmission.

As mentioned above, present encoders using rate control algorithms have been well optimized for a continuous stream of audio/video content that has an average amount of changes between frames. Present encoders are deficient, however, when the audio/video traffic is non-continuous. For instance, a slide presentation transmitted over a data network has long periods of no changes (when viewing a slide) followed by periods of rapid change (when changing slides). Present encoding systems are constrained by the rate control limitations during the bursting data periods of rapid change, and produce an overall poor quality result.

The present invention addresses this and other problems associated with the prior art.

### SUMMARY OF THE INVENTION

A data transmission scheduler sends different layers of encoded data transmissions over a transmission channel at different times, according to available bandwidth. Data in the lowest layer has the highest priority and is sent immediately to form a basic image. Higher layers, which enhance the basic image, have lower priorities and are sent during time periods of bandwidth otherwise unused. The scheduler tracks the amount of data sent and strives to maintain an overall datarate equal to an average target bitrate. In other embodiments, the scheduler can also maintain a maximum bursting datarate below a preset maximum, while still maintaining the average target bitrate.

### BRIEF DESCRIPTION OF THE DRAWINGS

FIG. 1A is a graph showing an analogy of video encoding using present encoding systems.

FIG. 1B is a graph showing an analogy of video encoding and transmission using embodiments of the present invention.

FIG. 2 is a block diagram showing components of a transmission system according to embodiments of the invention.

FIG. 3A is an example image showing an image that was encoded and decoded using only a base encoding layer.

FIG. 3B is an example image showing the same image as was shown in FIG. 3A, but instead was encoded and decoded using a base encoding layer and one enhancement layer.

FIG. 3C is an example image showing the same image as was shown in FIGS. 3A and 3B, but instead was encoded and decoded using a base encoding layer and two enhancement layers.

FIG. 4 is a flow diagram showing how data encoded into multiple layers is scheduled for transmission.

FIG. 5 is a flow diagram showing additional detail about scheduling data for transmission.

FIG. 6 is a flow diagram showing additional detail about scheduling data for transmission.

FIG. 7 is a block diagram showing an implementation of the data transmission scheduler as implemented in a computer network.

FIG. 8 is a graph showing bandwidth use in a data transmission network.

FIG. 9 is a graph showing bandwidth use in a data transmission network.

### DETAILED DESCRIPTION

The invention is directed to a data transmission system. Embodiments of the invention include an encoder that encodes a data input stream into multiple layers and a scheduler that sends the different layers of encoded data over a data channel. The scheduler uses different methods to maintain a target bit rate, or overall amount of bandwidth consumed by the transmission system.

The encoder encodes the input data stream into a base layer and one or more enhancement layers. The base layer includes enough information to recreate a viewable image when decoded by a decoder. The first enhancement layer adds detail to the image that was recreated using only the base layer. Second and subsequent enhancement layers add additional detail to the image when added to the lower layers.

A scheduler schedules transmitting the base and enhancement layers according to bandwidth already consumed by the transmission system. The base layer is transmitted as soon as it is received by the scheduler. Enhancement layers are transmitted when bandwidth is available, as determined by the scheduler. Various methods exist to determine available bandwidth, such as by measuring bandwidth already consumed by transmitting the prior layers, and/or by monitoring bandwidth resources available on the transmission channel. Maximum transmission rate limits can also be set so that the transmission system does not exceed a given data rate, even if additional bandwidth is available.

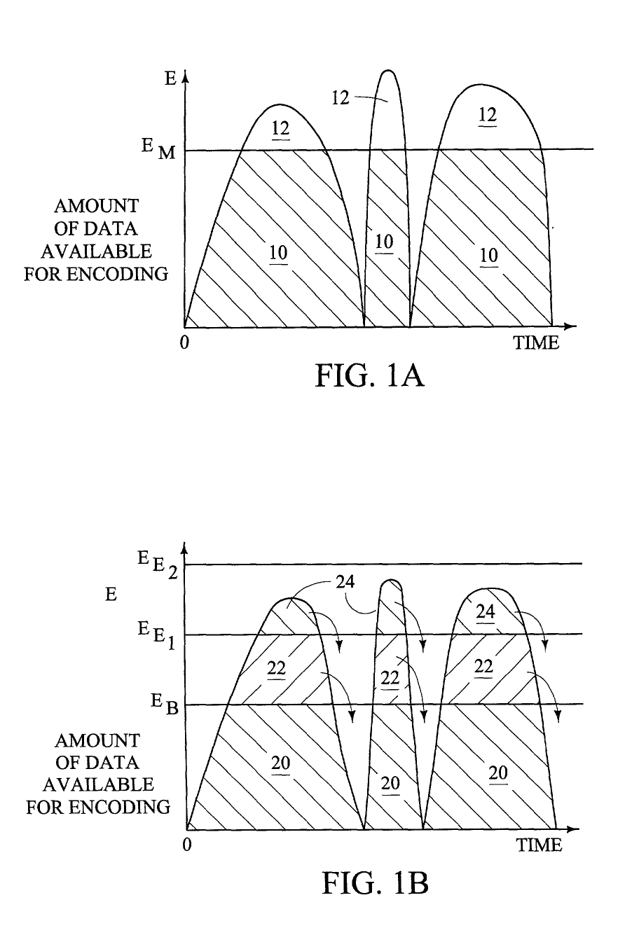

FIG. 1A is a chart showing an analogy of a prior art encoding scheme. The chart shows an amount of data presented to an encoder and available to be encoded vs. time. Variations in the graph (the up and down portions indicated by the solid line) represent the amount of encoding that would be needed to fully encode the incoming data. Indicated on the Y-axis is a level E_{M}, which represents the maximum amount of encoding able to be performed by a prior art encoder. The maximum level E_{M} is set by a rate control algorithm running on the encoder. Portions 10 of the graph (below E_{M}) represent the data that is actually encoded by the encoder. Portions 12 of the graph (above E_{M}) represent data that could be encoded by the encoder, except that the rate limitation E_{M} prevents this encoding. Therefore, portions 10 of the data are encoded for transmission while the portions 12 of the data are not encoded, and are simply discarded by the encoder. Not fully encoding all of the incoming data causes the aforementioned dropouts and interruptions when the data is later decoded.

FIG. 1B is a chart showing an analogy of the encoding and scheduling of a data stream according to embodiments of the invention. In that figure, the data available to be encoded also varies with time. However, in this instance all of the data is encoded into different layers—specifically a base layer and one or more enhancement layers.

Data 20 indicates data that is encoded into a base layer that, when recreated, forms an identifiable image. The upper bound of the data 20 is indicated by E_{B}, which is a base level of encoding. The level E_{B} may be above or below the level E_{M} of FIG. 1A, depending on the resources available to the respective encoders.

Data 22, which appears between levels E_{B} and E_{E1}, indicates a first enhancement data layer. This enhancement data layer 22 is added to the decoded base level data 20 to show additional features and detail to the decoded picture, if there is room in the transmission channel to send the enhancement data layer. Data 24, a second enhancement layer, appears between an encoding level E_{E1} and a second encoding level E_{E2}. The second enhancement layer 24 adds even further detail to the decoded picture. The second enhancement layer 24 is transmitted only after the base data 20 and first enhancement level data 22 are sent, and only if enough bandwidth is available to send it.

Arrows extending from the first and second enhancement data layers 22, 24 indicate that these layers are transmitted during times other than when the baselayer 20 is being transmitted. If enough bandwidth is available, the enhancement data layers 22, 24 could be transmitted at the same time the base layer 20 is transmitted, but this is not indicated on FIG. 1B.

An important distinction between the prior art and embodiments of the invention is that prior art systems limit the amount of the encoding performed on the data input stream due to the encoding rate limiting algorithms, and simply discard the data that exceeds those limits. Embodiments of the invention, conversely, encode the entire data input stream, even though parts of the encoded datastream may be blocked by the scheduler and not sent to a decoder.

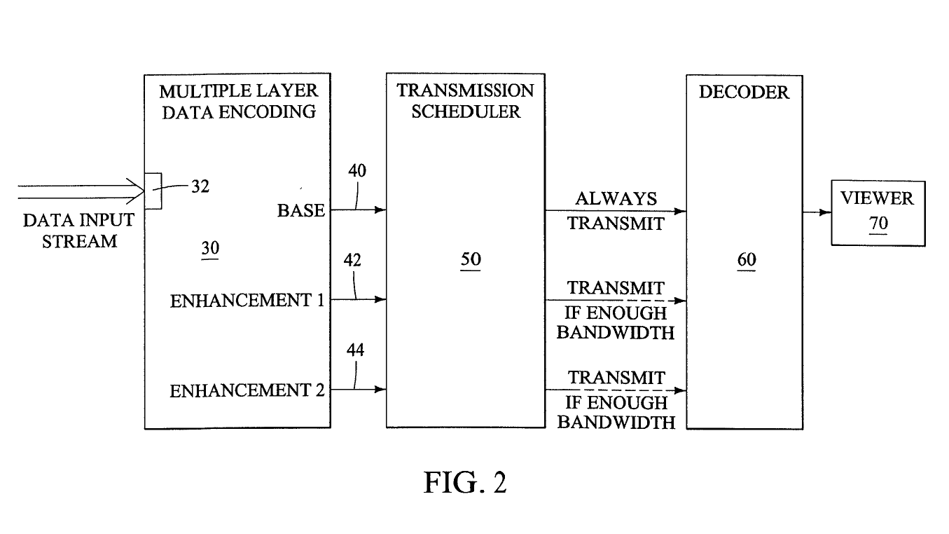

FIG. 2 is a block diagram showing a data transmission system according to embodiments of the invention. A data encoder 30 receives a data input stream at an input 32. The data input stream could be video, audio, or other data; and it need not be a continuous data stream but may have gaps in it. For example, the data input stream could be a recording of a speaking presentation where there are several time gaps, for instance between words, or at other times while the presenter is not speaking. Or, the data input stream could be a video slide show where slides are only changed every so often, or a video where a large percentage of the picture does not change very much or very often.

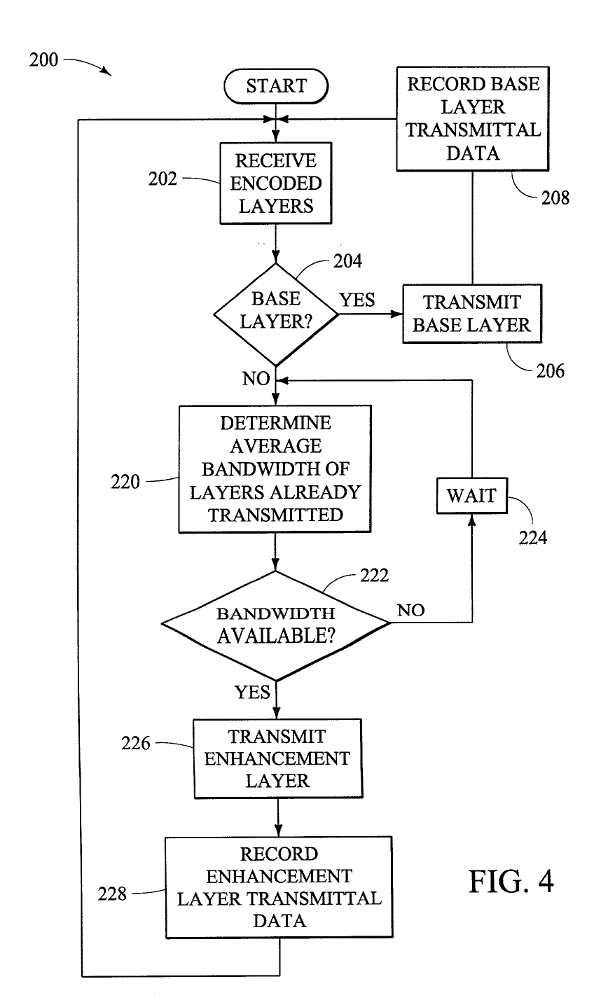

The encoder 30 encodes the data received at the input 32 into a base layer 40 and at least one enhancement layer 42. If the encoder 30 is sophisticated enough, and if implemented to do so, the encoder may also encode the data input stream into a second enhancement layer 44. Of course, there is no upper limit on how many enhancement layers the encoder 30 could produce, but this number would be determined when implemented. Each of the encoded layers, including the base layer 40 and any enhancement layer 42, 44 produced by the encoder 30 are sent to a transmission scheduler 50. The transmission scheduler 50 acts as a gatekeeper to a data transmission channel between it and one or more decoders 60 (only one shown). This transmission channel could be a bus within a computer, a LAN connection between two or more computers, or a connection between a computer and the Internet or another network. The transmission scheduler 50 includes a rate control operation that will be discussed with reference to FIG. 4 and following. The rate control operation running on the transmission scheduler 50 is instructed to transmit the base layer 40 immediately after receiving it from the encoder 30. The transmission scheduler 50 then determines if there is enough bandwidth available on the data transmission channel to also send the enhancement layers 42, 44 to the decoder 60. The ability to send the enhancement layers 42, 44 over the transmission channel is determined individually in that, if there is no available bandwidth other than that for the base layer 40, none of the enhancement layers 42, 44 will be sent. Or, if there is only enough bandwidth to send the first enhancement layer 42 over the transmission channel, then only the first enhancement layer 42 will be sent and the second enhancement layer 44 will not be sent. This procedure applies to all of the enhancement layers encoded by the encoder 30. The transmission scheduler 50 continues to try to send all of the enhancement layers 42, 44 until the decoder 60 can no longer utilize them, e.g., until a different image is generated or the data transmission has ended.

The decoder 60 receives all of the encoded data sent by the transmission scheduler 50 and generates an image on a display device 70. The decoder 60 includes software or hardware functions that allow it to recreate a video image even if that image is sent to it in more than one layer. For instance, the decoder 60 will create, as best it can, the image after having received the base layer 40. If the decoder 60 then receives one or more enhancement layers 42, 44, the decoder automatically increases the quality of the generated video image, and updates the previous image shown on the display device 70. In some embodiments the decoder 60 may buffer or otherwise locally store the received image for a time prior to showing it on the display device 70 so that the best possible image can be initially created. If parameters determine that the image must be shown as soon as possible, however, then the decoder 60 will not delay generating its image any longer than is necessary.

Although shown as distinct blocks in FIG. 2, the scheduler 50 and encoder 30 could be implemented together in one device or circuit. FIG. 2 is a block diagram of the functions described and does not necessarily show how those functions are implemented.

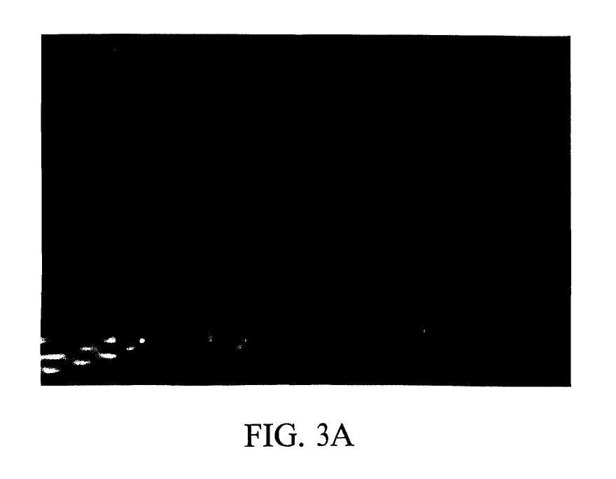

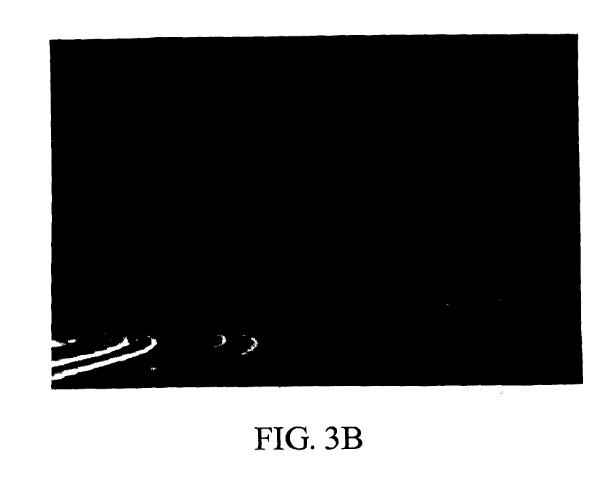

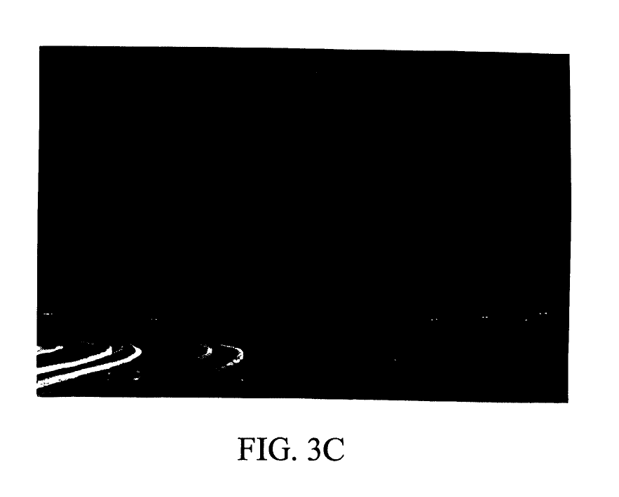

FIG. 3A shows an example of an image that was encoded and later decoded using only data from the base layer 40, and none of the enhancement layers 42, 44. As can be seen, much of the detail is missing from the image, although a viewer can fairly easily determine that the image is the Arc de Triumph in Paris, France, The main parts of the image are identifiable. FIG. 3B shows the same image after having been recreated from the base layer 40 and the first enhancement layer 42. In this figure, many more details of the image can be seen, such as the carvings on the monument and the clouds in the sky. Finally, FIG. 3C shows the same image after having been recreated from the base layer 40 as well as the first and second enhancement layers 42, 44. In this image, all of the detail from the original picture has been recreated, and the image is crisp and sharp. Thus, transmitting the base layer 40 immediately allows a recognizable image to be created and, if enough bandwidth exists, details can be added by transmitting and decoding the enhancement layers 42, 44. While it is always preferable to have an image created by both the base layer 40 and any enhancement layers 42, 44, it is not absolutely necessary to send more than the base layer 40 to create an image that can be recognized.

FIG. 4 shows an example flow diagram of a transmission rate control operation that can work with the transmission scheduler 50 of FIG. 2. The flow 200 begins at step 202 by receiving one or more encoded data layers from the encoder 30. As discussed above, the encoded data layers will include at least a base layer 40 and may include one or more enhancement layers 42, 44. Step 204 checks the received layers to determine if any of them are a base layer 40. If a base layer 40 is detected, it is, as far as possible, sent to step 206 to be transmitted over the data channel. Step 208 then records various details about the transmitted base layer 40, such as the number of bytes transmitted and the time period in which those bytes were transmitted. The flow 200 then returns to step 202. The steps 202, 204, 206, and 208 can be thought of as a continuous thread that is always running on the transmission scheduler 50. Thus, the transmission scheduler 50 may be transmitting a base layer 40 in step 206 while it is also receiving other data layers in step 202.

If instead step 204 determines that the received layer is not a base layer 40, step 220 uses the data recorded in step 208 (and in step 228, discussed below) to determine an average bandwidth already used by the scheduler 50 in transmitting the previous layers. A decision block 222 determines if there is bandwidth available to the transmission scheduler 50 for sending additional layers. There will be bandwidth available to the transmission scheduler 50 if transmitting the previous layers did not use all of the bandwidth allocated to the transmission scheduler.

If step 222 finds there is no bandwidth remaining to the transmission scheduler, the flow 200 proceeds to step 224, where the flow waits a predetermined amount of time. Waiting in step 224 increases the amount of bandwidth available to the transmission scheduler 50, because more time has passed since data has been sent. For instance, if the transmission scheduler has sent 1 million bits over the last second, then, by waiting an additional second, the consumed bit rate falls to 0.5 million bits per second over the last two seconds. Steps 220, 222, and 224 must also account for the possibility that the thread made by steps 202, 204, 206 and 208 continually transmits base layers 40 when they are received. Therefore, step 222 cannot simply determine how many seconds it must wait before the average bandwidth will come down to acceptable levels, but rather step 222 must continually check the actual bandwidth sent by the scheduler 50, because a base layer 40 could have been recently transmitted, affecting the bandwidth used.

After step 224 waits a time period, the flow 200 returns to steps 220 and 222 where any available bandwidth is again determined. Once there is bandwidth available to the scheduler 50, as determined by step 222, step 226 transmits the first enhancement layer 42, or a portion of the first enhancement layer (such as one or more packets) over the transmission channel. Step 228 records the number of bytes transmitted and the time period used for the transmission, which is added to the overall bandwidth used by the transmission scheduler 50. Determining the past bandwidth used in step 220, checking for bandwidth remaining in step 222 and transmitting and recording the enhancement layers in step 226 and 228 are performed for each enhancement layer 42, 44 separately and in order of enhancement layer. For instance, the flow 200 will determine whether it can transmit the enhancement layer 42 prior to making the determination for the enhancement layer 44. In some embodiments, the flow 200 may try to determine whether all layers already received in step 202 can be sent at once, prior to determining which ones of the individual received layers 40, 42, 44 can be sent.

Additionally, while all the calculations of bandwidth and transmittals of different layers are being executed by the transmittal scheduler 50, step 202 is still receiving other encoded data layers from the encoder 30. Standard queue management or other techniques that are well known in the art could be used to solve the problem of receiving some layers while operating on others.

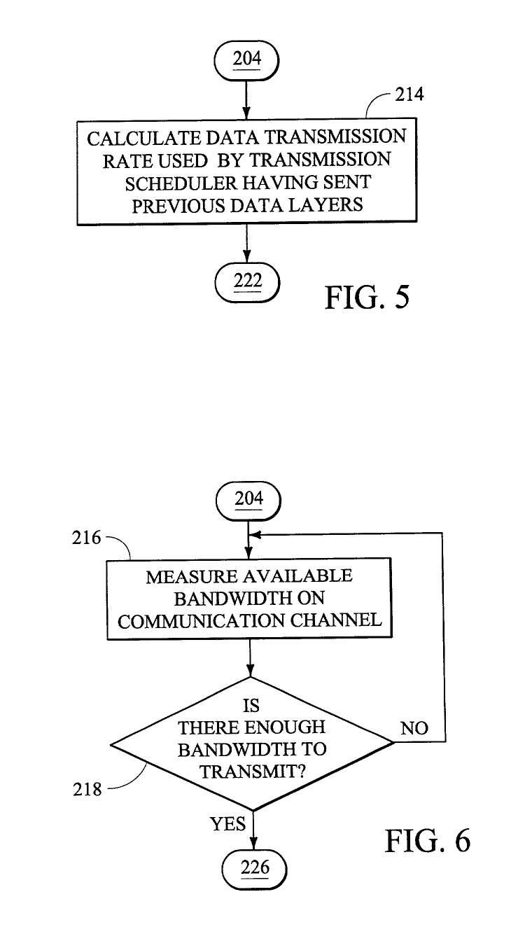

FIG. 5 shows additional detail about step 220 in FIG. 4. Specifically, FIG. 5 shows one way for step 220 to determine the amount of bandwidth already used by the transmission scheduler 50 in transmitting the previously transmitted base and enhancement layers. As shown in FIG. 5, one way to determine the amount of bandwidth already used is to calculate the amount of data sent over a last measuring period. Step 214, which is placed between steps 204 and 222 of FIG. 4, performs the calculations of the bandwidth. The measuring period can be in the form of time, such as how many bytes were transmitted per second over the last “x” number of seconds (or minutes), or can be in the form of data, such as how many bytes were transmitted per second over the last “n” amount of bytes or packets.

All the data needed to calculate the bandwidth already used by the scheduler 50 was recorded in steps 208 and 228, and continues to be updated when the scheduler transmits new data. In step 214 of FIG. 5, the used bandwidth is calculated by determining how much data has been transmitted per unit time over a last measuring period. In this way, the flow 220 can maintain an overall data transmission bandwidth within a target datarate. For instance, the flow 200 may have a target datarate of 1 megabit per second transmitted over the data channel by the scheduler 50. If transmission of the base layer 40 only consumes ½ megabit per second, then the flow 200 can use the other half of the megabit per second to transmit the enhancement layers 42, 44, if present.

In calculating the bandwidth used by the flow 200, several methods can be used. In one method, step 214 calculates the instantaneous bandwidth of the scheduler 50 for every one-second interval. Any interval, such as two, five or 60 seconds could alternatively be used. Another way to calculate the used bandwidth is by using a fixed number of last transmitted bytes or packets. For instance, an average bandwidth can be calculated for the last 10, 100 or 1000 packets sent by the scheduler 50, or for the last five or 10 million bytes. Step 214 may also calculate and track several bandwidths simultaneously, such as by calculating an instantaneous bandwidth covering the last few seconds or packets, and also calculating an average bandwidth covering a longer period of time, such as one or more minutes. This information can then later be used by step 222 of FIG. 4 to determine whether enough bandwidth that was allocated to the scheduler 50 remains to send any enhancement layers 42, 44 that were received by the flow 200. For instance, if the scheduler 50 has had a low bandwidth use rate over the last minute, the flow 200 may be more inclined to temporarily exceed an instantaneous bandwidth than if the scheduler has had a high bandwidth use rate over the last minute.

Once the amount of bandwidth already used by the scheduler 50 is determined in step 214, step 222 compares the amount of bandwidth already used with a target bandwidth rate that was predetermined for the scheduler. Step 222 strives to maintain the average bandwidth rate of the scheduler 50 within the targeted rate by determining whether the enhancement layers 42, 44 awaiting transmittal (if any) can be sent while still remaining under the target bandwidth rate. In some embodiments, step 222 will allow the scheduler 50 to transmit data layers even if the flow 200 has temporarily exceeded its target bandwidth.

Shown in FIG. 6 is an alternative method to determine if and when the enhancement data layers 42, 44, in the flow 200 will be sent over the data channel. In that figure, instead of calculating the average bandwidth as in step 214 of FIG. 5, step 216 actually measures the amount of bandwidth available on the network. This step works in conjunction with step 218 in that the flow 200 will send the enhancement layers 42, 44 if there is enough bandwidth available on the network, regardless of the amount of bandwidth already used by the scheduler 50. Using the flow described in FIG. 6., the flow 200 will send the enhancement layers 42, 44 over the communication channel, even if it means temporarily exceeding the allocated or target bandwidth for the transmission scheduler 200. For instance, if the target bandwidth is 1 megabit per second and the flow 200 is already transmitting at that level, but step 216 determines, by measuring the instantaneous bandwidth available on the network, that there is bandwidth still available on the network, then the flow 200 will transmit the enhancement layers 42, 44 anyway, even if it means exceeding 1 megabit per second. Of course, there is a practical limit to the rate of data transmission in that the decoder 60 must be able to keep up with the amount of traffic received. The procedure used as shown in FIG. 6 has a real world application in that it can take advantage of any unused bandwidth available on the transmission channel.

The interplay between measuring the bandwidth on the communication channel in step 216 and deciding whether to send the enhancement layers 42, 44 even if the bandwidth allocated to the scheduler 50 has been exceeded, is largely left to implementation, and the specifics may best be determined empirically.

These described methods to determine whether to send the enhancement layers 42, 44, i.e., by calculating a bandwidth average bandwidth already used as shown in FIG. 5 or by measuring the instantaneous bandwidth available on the communication channel as shown in FIG. 6, or other methods that are used, may also include a maximum transmission rate limit of the scheduler 50. For instance, step 222 of FIG. 4 or step 218 of FIG. 6 may contain a limitation that they will not direct the flow 200 to send the enhancement layers if it would cause the scheduler 50 to consume above a certain bandwidth. This plan can be adopted when specifications of the communication channel provide that no process can transmit more than a certain amount on the communication channel.

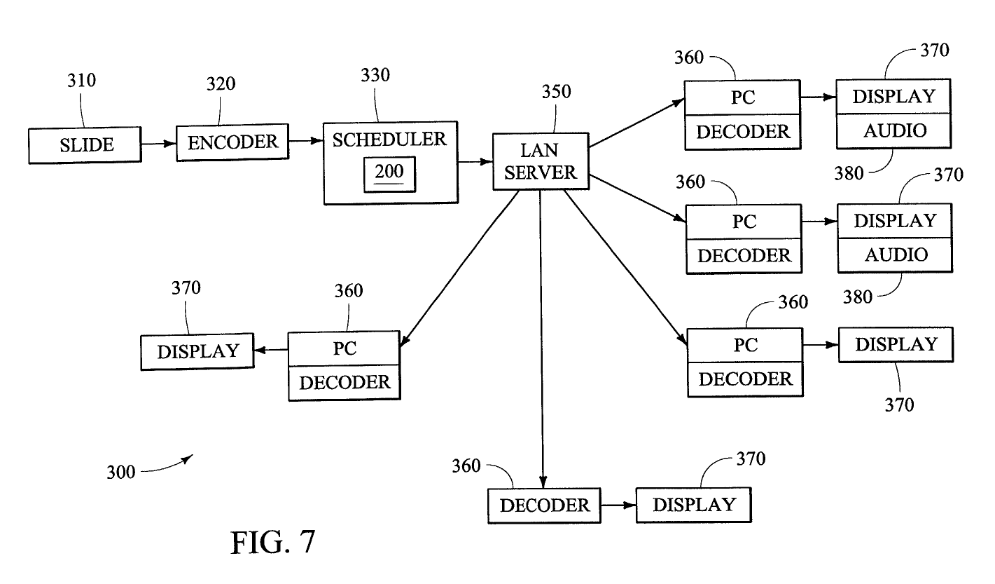

FIG. 7 shows a digital transmission system 300 capable to implement embodiments of this invention. A data source 310 is used to create a data input stream. For example, this data source 310 could be a slide presentation system where a presenter is showing a set of static slides. The presenter, by using a switching device (not shown), can select between different slides in either a forward or backward direction. The slide show data is presented to an encoder 320 that encodes all of the slide show data into a base encoded layer 40 and two enhancement layers, 42 and 44. The encoder 320 sends these encoded layers 42, 44 to a transmission scheduler 330 that includes the scheduling and transmitting functions described above. Running within the transmission scheduler 330 is the flow 200 shown in FIGS. 4-6, or another implementation method. The output of the transmission scheduler 330 is sent to a media server 350. The server 350 sends the encoded presentation data layers 40, and possibly the enhancement layers 42 and 44, to multiple decoders 360. The decoders 360 generally run on their own Personal Computer (PC), but any implementation may be used, such as multiple decoders on a single PC, or a decoder running on a device that is not a PC. Connected to each of the decoders 360 is a display 370, used to show the slide presentation to a multitude of users. The display 370 may additionally be coupled to or include an audio portion 380 used to produce sounds that accompany the images shown on the display. In some embodiments, the decoders 360 only produce an output for the audio portion 380, and not for the display 370. These embodiments may be used when bandwidth of the network to which the decoders 360 are coupled is restricted.

As discussed with reference to FIG. 2, the functional blocks shown in FIG. 7 do not necessarily show how the represented functions will be implemented. For instance, the scheduler 330 could also include the encoder 320 in the same device. Additionally, the media server 350 could be incorporated within the scheduler 330, with or without the encoder 320. Such implementation details are well known in the art and could be implemented by one skilled in the art without considerable experimentation.

In operation, as the presenter flips through slides in the data generator 310, the slides are encoded by the encoder 320 and scheduled for transmission by the transmission scheduler 330. The encoded data, as described above, includes both base layer encodings 40 as well as one or more enhancement layers 42, 44. These transmissions are duplicated by the media server 350 and sent to each of the decoders 360, where the slide presentation is recreated on the respective displays 370. If the network to which the media server 350 is connected has very little bandwidth available for the transmission scheduler 330, then the scheduler will only be able to send the base layer 40 to the decoders 360. This means that the image recreated on the display 370 may be of a marginal quality when reproduced. If, instead, the network to which the media server 350 is connected has an adequate bandwidth available for the transmission scheduler 330, then the scheduler will be able to send the base layer 40 as well as the enhancement layers 42, 44 to the decoders 360. This means that the image recreated on the display 370 should be of the highest quality possible.

Thus, as the presenter flips through slides, representations of these same slides appear on the displays 370, and the quality of the representations is related to the amount of bandwidth available to the transmission scheduler 330.

Although in FIG. 7 five displays 370 are shown, any number could be present within the system 300. Additionally, the decoders 360 that are coupled to the displays 370 may be on the same network as the data generator 310, as shown in FIG. 7, or the decoders could be located far away from the data generator and only reachable through a distributed network.

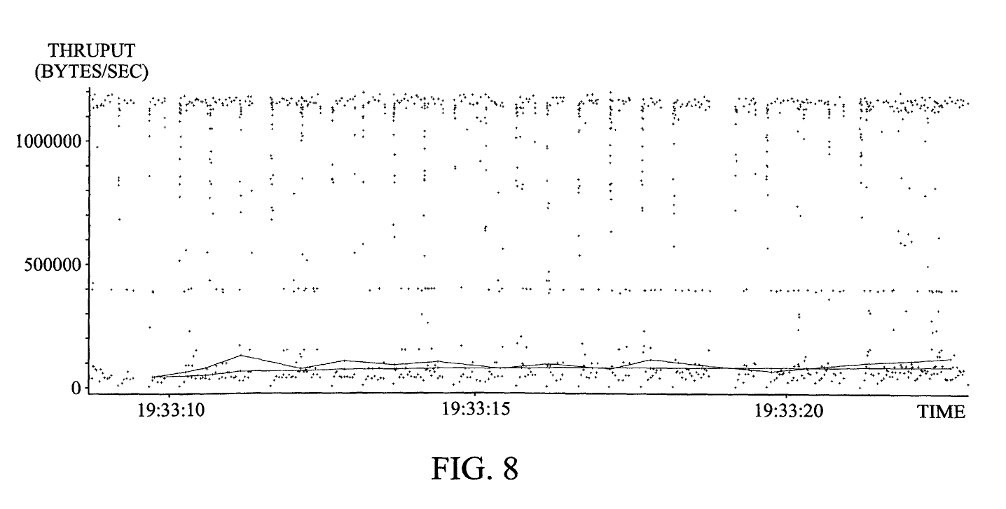

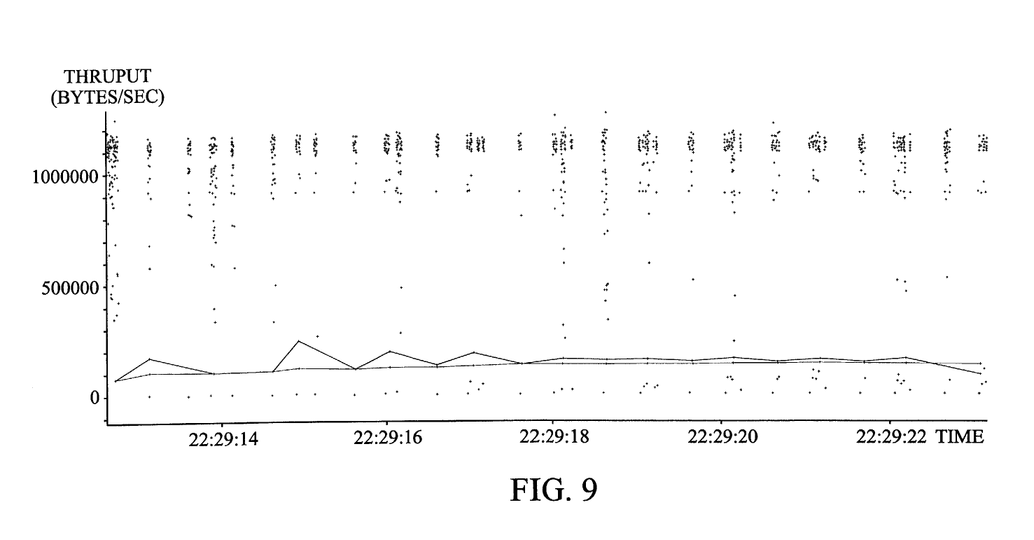

In a system such as that shown in FIG. 7, the most difficult scheduling problem for the scheduler 330 occurs during a fast forward or a fast backward operation, where the user is going quickly through a presentation and flipping slides one after another. FIGS. 8 and 9 are charts that show instantaneous throughput during a fast-forward through a first and a second slide sequence, each having 28 different slides. The interval between successive slides is 500 msec.

The first slide sequence, used to create FIG. 8, includes slides on a simple white background, without any additional background detail. The foreground and the simple white background were encoded into a base layer 40 and one enhancement layer 42. The average packet size for the base layer 40 is 96,444 bits, while the first enhancement layer 42 is 169,125 bits.

The second sequence of slides, used to create FIG. 9, includes images having a background more complex than the ones used to create FIG. 8. The second sequence is encoded into a base layer 40 having 238,460 bits, and a first enhancement layer 42 having 429,827 bits.

FIG. 8 shows a plot of the instantaneous throughput for the first sequence, having the white background, during a fast forward operation for 28 successive slides. Long term and a shorter term transmission datarates are also indicated by continuous lines, near the bottom of FIG. 8. As is expected, these averages are very close to the targeted datarate of 1 Mbps, and the shorter term average has more hills and valleys than the longer average. FIG. 9 shows a similar plot for the second sequence, also including the long and short term averages. In both examples the transmission scheduler 350 had target transmission rate of 1 Mbps. As can be seen, because of the bursty nature of traffic generation, the instantaneous throughput is high in both examples, often exceeding 1,000,000 bytes per second (at eight bytes per bit, this exceeds 8,000,000 bits per second (bps)). By using a controlling mechanism that sends the base layer 40 right away and then controls when to send the enhancement layer 42, such as described above, an average bit rate can be reached in each of these examples that is very close to the desired 1 Mbps.

As can be seen from examining differences between FIGS. 8 and 9, the layers of the slides having a white background (FIG. 8) are more easily scheduled than the slides having a detailed background (FIG. 9), because of their size difference. This results in a more uniform scheduling for transmitting the slides having the non-detailed background. Because the base layer 40 and enhancement layer 42 in the second sequence are larger than the first sequence, the instantaneous throughout is very bursty, with periods where the transmission scheduler 330 is waiting relatively long periods to schedule packets, because of the average transmission bandwidth exceeding the average target bandwidth.

The above-described system can be implemented in a variety of ways, while keeping within the scope of the invention. For instance, the system can use dedicated processor systems, micro controllers, programmable logic devices, or microprocessors that perform some or all of the scheduling operations. Some of the operations described above may be implemented in software and other operations may be implemented in hardware.

Additionally, while described as a system for transmitting layers, the same considerations apply to transmitting pieces of layers, or packets of data containing layer information. Although it is possible that the entire layer be transmitted at one time, generally the layers can be thought of as being broken into packets prior to transmission and the packets reassembled into layers after transmission.

For the sake of convenience, the operations are described as various interconnected functional blocks or distinct operations. This is not necessary, however, and there may be cases where these functional blocks or modules are equivalently aggregated into a single logic device, program or operation with unclear boundaries. In any event, the functional blocks and software modules or described features can be implemented by themselves, or in combination with other operations in either hardware or software.

Having described and illustrated the principles of the invention in a preferred embodiment thereof, it should be apparent that the invention could be modified in arrangement and detail without departing from such principles. Claim is made to all modifications and variation coming within the spirit and scope of the following claims.

1. A method for transmitting data over a transmission channel, comprising:
accepting, at an input of a data transmitter, data that has been encoded into a base layer and an enhancement layer;
transmitting the base layer on the transmission channel;
determining if there is enough bandwidth available to the data transmitter to transmit data in addition to the base layer already transmitted; and
transmitting the enhancement layer if there is enough bandwidth available to transmit another layer.

2. The method of claim 1 wherein determining if there is enough bandwidth available to the data transmitter to transmit data in addition to the base layer comprises calculating a bandwidth previously used by the data transmitter in previously transmitting layers.

3. The method according to claim 1 wherein determining if there is enough bandwidth available to the data transmitter to transmit data in addition to the base layer comprises measuring data traffic on the transmission channel to determine if enough bandwidth exists to transmit additional layers.

4. The method according to claim 1 wherein the data transmitter has a pre-set target data rate, and wherein determining if there is enough bandwidth available to the data transmitter to transmit data in addition to the base layer already transmitted comprises determining whether an average bandwidth used by the data transmitter over a last measuring period is below the pre-set target data rate.

5. The method according to claim 4 wherein the last measuring period is a period of time.

6. The method according to claim 4 wherein the last measuring period is a period in which a predetermined number of pieces of data have been transmitted over the transmission channel by the data transmitter.

7. The method according to claim 1 wherein the data transmitter has a pre-set maximum transmission rate, and wherein the data transmitter ensures that its rate of transmitting data is below the pre-set maximum transmission rate.

8. The method according to claim 1 wherein the data is additionally encoded as a second enhancement layer, the method further comprising:
determining if there is enough bandwidth available to the data transmitter to transmit data in addition to the base and enhancement layers already transmitted by the data transmitter; and
transmitting the second enhancement layer if there is enough bandwidth available to transmit the second enhancement layer.

9. The method according to claim 1 wherein transmitting the base layer on the transmission channel comprises transmitting the base layer on a LAN connection between two or more computers.

10. The method according to claim 1 wherein transmitting the base layer on the transmission channel comprises transmitting data from a media server to an image projector.

11. The method according to claim 1 wherein transmitting the base layer on the transmission channel comprises transmitting data from a media server to a decoding device.

12. The method according to claim 1 wherein determining if there is enough bandwidth available to the data transmitter to transmit data in addition to the base layer already transmitted comprises calculating at least two average bandwidths used by the data transmitter, each of the average bandwidths calculated over different measuring periods.

13. A multi-layer data transmission system, comprising:
a transmission scheduler having a first data input configured to accept an encoded base layer of data and an enhancement layer of data, and the transmission scheduler having an output terminal; and
a scheduling operation controlling the transmission scheduler and configured to cause the transmission scheduler to send the base layer of data from the output terminal of the transmission scheduler when it is received; and configured to determine if there is enough bandwidth to send the enhancement layer of data.

14. The data transmission system according to claim 13 wherein the scheduling operation is also configured to send the enhancement layer of data from the output terminal of the transmission scheduler if there is enough bandwidth to do so.

15. The data transmission system according to claim 14, wherein there is enough bandwidth to send the enhancement layer if an average data transmission rate of the transmission scheduler is less than a predetermined rate.

16. The data transmission system according to claim 14, wherein there is enough bandwidth to send the enhancement layer if there is available bandwidth on a transmission channel coupled to the output terminal of the transmission scheduler.

17. A data transmission system, comprising:
an encoder having an input for receiving a data stream and configured to encode the data stream into a base layer and at least one enhancement layer;
a transmission scheduler coupled to the encoder and having an input terminal to accept the encoded layers of data, and having an output terminal coupled to a transmission channel;
a scheduling operation running on the transmission scheduler and configured to signal the transmission scheduler to send the base layer of data from the output terminal of the transmission scheduler after it is received, and configured to determine the bandwidth used by the transmission scheduler sending the base layer; and
a decoder coupled to the transmission channel and configured to generate an image on a display based on the encoded layers of data received from the transmission scheduler.

18. The data transmission system of claim 17 wherein the scheduling operation is configured to determine whether there is enough bandwidth available to the transmission scheduler to send a first of the at least one enhancement layers from the output terminal of the transmission scheduler.

19. The data transmission system of claim 18 wherein the scheduling operation is configured to determine there is enough bandwidth available to the transmission scheduler when an average bandwidth rate used by the transmission scheduler is less than a target bandwidth rate.

20. The data transmission system of claim 18 wherein the scheduling operation is configured to determine there is enough bandwidth available to the transmission scheduler when an instantaneous bandwidth rate on the transmission channel is below a predetermined rate.

21. The data transmission system of claim 17 wherein the scheduling operation is configured to determine whether there is enough bandwidth available to the transmission scheduler to send a first and a second of the at least one enhancement layers from the output terminal of the transmission scheduler.

22. The data transmission system of claim 21 wherein the scheduling operation is configured to determine whether there is enough bandwidth available to the transmission scheduler to send the first of the at least one enhancement layers from the output terminal of the transmission scheduler prior to determining whether there is enough bandwidth available to the transmission scheduler to send the second of the at least one enhancement layers.
